(19) United States
(12) Patent Application Publication
(10) Pub. No.: US 2008/0300699 A1
(43) Pub. Date: Dec. 4, 2008

(54) Golf handicap and statistics display unit

(76) Inventor: Jack L. Smith, JR., Oxford, PA (US)

Correspondence Address: JAMES RAY & ASSOCIATES, 2640 Pitcairn Road, Monroeville, PA, 15146, US

(21) Appl. No.: 12/150,825

(22) Filed: May 1, 2008

Related U.S. Application Data
(60) Provisional application No. 60/940,717, filed on May 30, 2007.

(51) Int. Cl. G06F 19/00

(52) U.S. Cl. 700/93

(57) ABSTRACT

An apparatus for calculating a golfer's handicap and other statistics for determining such golfer's strengths and weaknesses. The apparatus comprises a portable unit containing software for recording, storing and analyzing pertinent data. A keyboard is disposed on one side of the portable unit for entering data, such keyboard having an alphanumeric keypad and function keys. There is a means disposed in the apparatus for outputting the analyzed data that had been previously inputted into the portable unit. A power means is disposed in the portable unit for providing power to such portable unit.

### CROSS REFERENCE TO RELATED APPLICATIONS

This application is closely related to and claims benefit from U.S. Provisional Application Ser. No. 60/940,717 filed May 30, 2007.

### FIELD OF THE INVENTION

The present invention relates, in general, to a golf apparatus, and, more particularly, the present invention relates to a golf tool that provides golfers with an apparatus which can determine a golfer's handicap and further provide information on such golfers strengths and weaknesses through statistical analysis of fairways hit in regulation, greens in regulation, number of putts, sand saves and penalties.

### BACKGROUND OF THE INVENTION

The game of golf is a challenging game since every shot is unique and every course has its peculiarities. The number of golfers keeps growing every year and every golfer is interested in improving his/her game. It is difficult for the majority of these golfers to realistically analyze their game to determine where they do well and the parts of their game that needs improving. The golfers have some idea of their strengths and weaknesses but this is mostly just by feel.

Thus, it would be advantageous if there were an apparatus or a tool by which the golfer could easily record specific items from his golf game as he/she is playing and thereby keep track of these items as to obtain a true statistical evaluation of his/her strengths and weaknesses after a few rounds of golf.

### SUMMARY OF THE INVENTION

In a first aspect the present invention provides an apparatus for calculating a golfer's handicap and other statistics for determining such golfer's strengths and weaknesses. The apparatus comprises a portable unit containing software for recording, storing and analyzing pertinent data. A keyboard is disposed on one side of the portable unit for entering data, such keyboard having an alphanumeric keypad and function keys. There is a means disposed in the apparatus for outputting the analyzed data that had been previously inputted into the portable unit. A power means is disposed in the portable unit for providing power to such portable unit.

In a second aspect there is provided a method for calculating a golfer's handicap and other statistics and for determining a golfer's strengths and weaknesses, through the use of a portable unit containing software for recording, storing and analyzing pertinent data, the method comprises the steps of turning on the portable unit and inputting course information including par, slope rating, individual hole pars, and yardage. There is a step of inputting the score on each hole played and a step of calculating user's current handicap as well as other statistics and a step of displaying information on today's round of golf as well as a step of displaying averages for past rounds on this course as well as averages for the year.

### OBJECTS OF THE INVENTION

It is, therefore, one of the primary objects of the present invention to provide golfers with a convenient easy to use tool by which they can determine their handicap.

Another object of the present invention to provide a convenient easy to use tool that can provide the golfer with his/her strengths and weaknesses.

Still another object of the present invention to provide a convenient easy to use tool that is hand held.

Yet another object of the present invention to provide a tool for providing the golfer with his/her strengths and weaknesses that is inexpensive.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is front view of the apparatus for calculating a golfer's handicap along with other statistics.

FIG. 2 is aback view of the apparatus shown in FIG. 1.

FIG. 3 is a bottom view of the apparatus shown in FIGS. 1 and 2 showing the label printout port.

FIG. 4 is a right side view of the apparatus shown in FIGS. 1 and 2 showing the on/off button and the USB port.

FIG. 5 is a left side view of the apparatus shown in FIGS. 1 and 2 showing the AC adapter plug.

FIG. 6 is a front perspective view of an attachment means that includes a holder member.

FIG. 7 is a back view of the holder shown in FIG. 6.

FIG. 8 is a side view of the holder member shown in FIG. 6 showing the slot for attachment to a user's belt and the female receiver.

FIG. 9 is a top view of the attachment means for attaching such holder member to a golf bag, a golf cart or a steering wheel of such golf cart.

FIG. 10 is side view of the swivel base and male insert shown in FIG. 9.

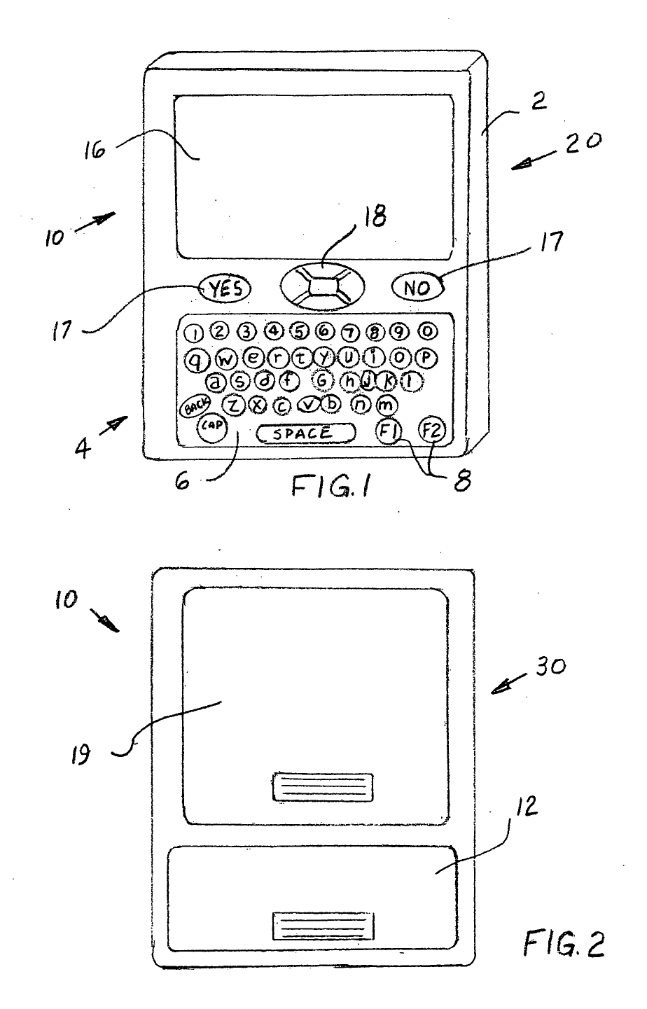

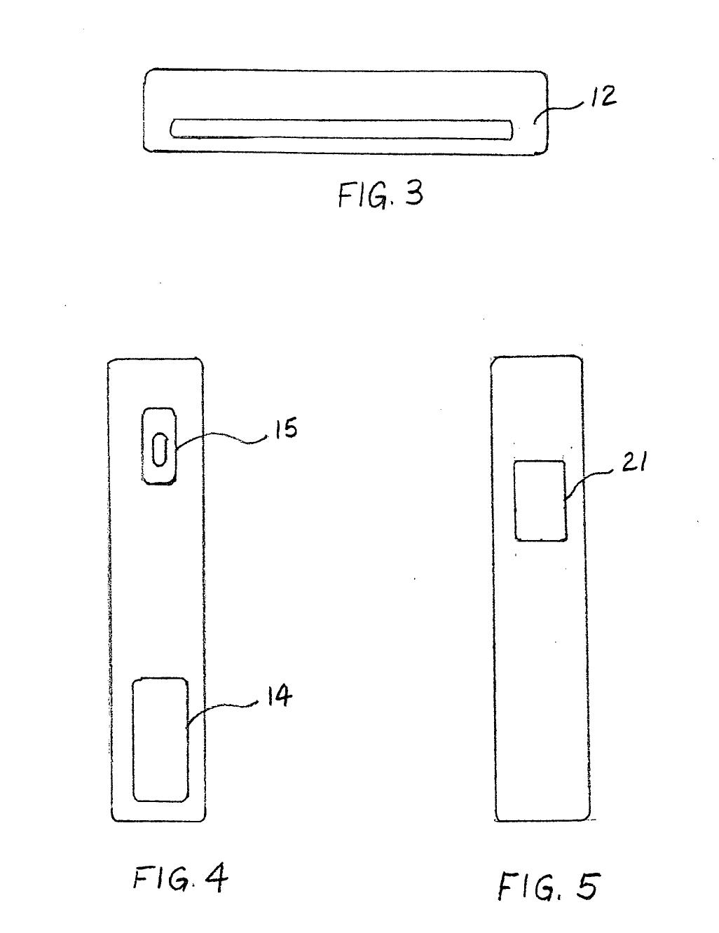

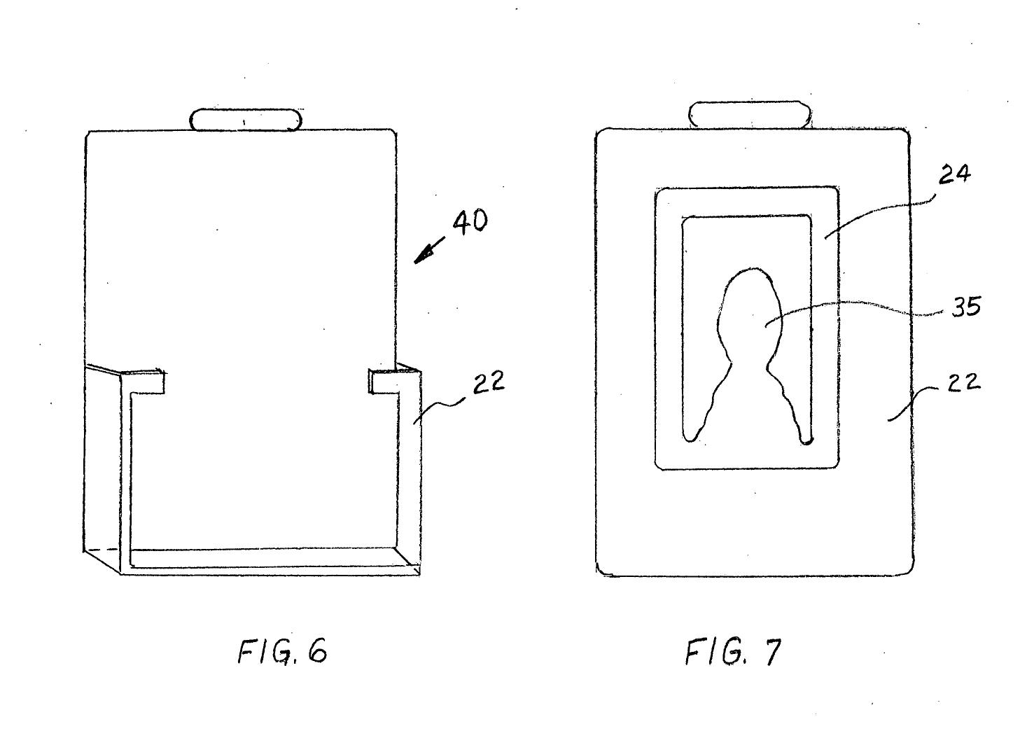

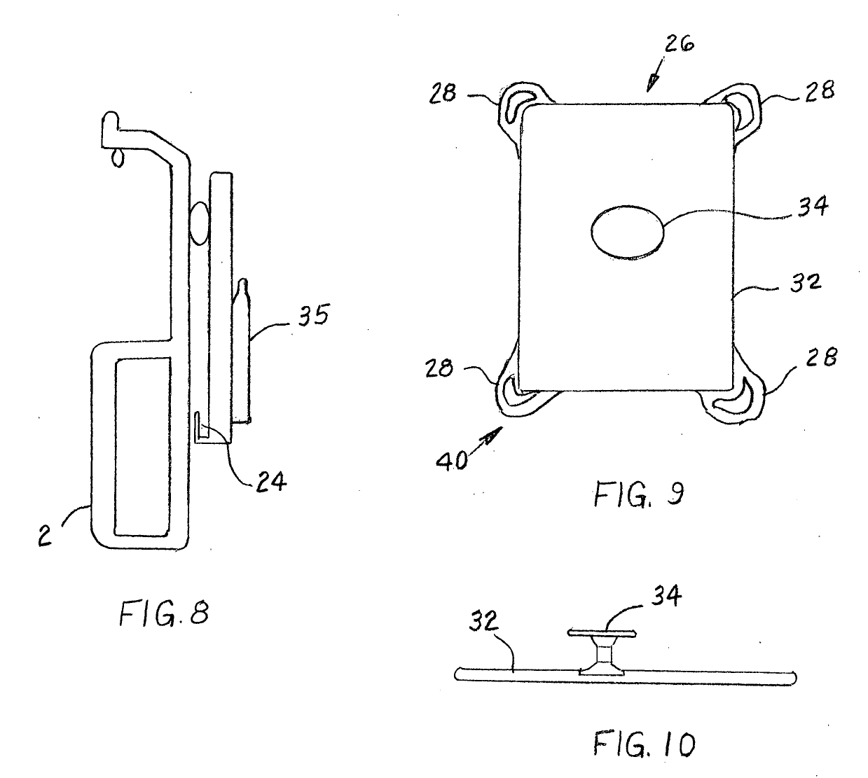

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for calculating a golfer's handicap and other statistics for determining such golfer's strengths and weaknesses. The apparatus comprises a portable unit 2 containing software for recording, storing and analyzing pertinent data. The portable unit has a predetermined size and a predetermined shape. A keyboard 4 is disposed on one side of the portable unit 2 for entering data, such keyboard having an alphanumeric keypad 6 and function keys 8. There is a means, generally designated 20, disposed in the apparatus 10 for outputting the analyzed data that had been previously inputted into the portable unit 2. A power means, generally designated 30, is disposed in the portable unit 2 for providing power to such portable unit 2. Such power means 30 includes at least one battery 20 disposed in the back portion of the portable unit 2 behind the removable battery panel 19 and it is presently preferred that such battery 20 includes one of a nine volt battery or at least two AA batteries. The power means 20 also includes an AC plug adapter 21 for connecting to a 110 volt outlet. Such portable unit 2 further includes an on/off button 15 disposed on a right side of the unit 2.

The portable unit 2 of such apparatus 10 also includes a label printer 12 for printing such golfer's handicap. The portable unit further includes a universal serial bus port (connector) 14 for sending data to a personal computer. There is a display screen 16 disposed on the portable unit on the same side as the keyboard 4 for outputting analyzed data. Such portable unit 2 features characteristics of existing Personal Digital Assistants.

The keyboard 4 portion of the portable unit further includes yes and no keys 17 on the keyboard for answering questions posed by the apparatus 10. There is further a directional control 18 disposed on the front side of the portable unit 2 for moving a cursor up and down and left and right.

The apparatus further includes an attachment means 40 for securing the portable unit 2 to one of a golfer's belt, a golf bag or a golf cart. It should be noted that such apparatus is a hand held unit and is lightweight so it is easy to carry; however, it is frequently desired for the unit to be attached to a belt, golf bag or golf cart. The predetermined size of the unit is between about 4¾ and about 5¼ inches long and between about 2¾ and about 3¼ inches wide.

Such attachment means 40 includes a holder member 22. Such holder member 22 has a slot 24 for engagement with a user's belt. It is within the concept of the invention that there could be a clip instead of a slot 24 for engaging a belt. The attachment means 40 also includes a unit 26 having Velcro (hook and loop) straps 28 for engagement with a golf bag, a golf cart or a steering wheel of such golf cart. Such attachment means 40 also includes a swivel base 32 and a male insert 34. Such male insert 34 engages a female receiver 35 on the back of the holder member 22 and permits the unit to swivel to a position as desired.

In a second aspect there is provided a method for calculating a golfer's handicap and other statistics and for determining a golfer's strengths and weaknesses, through the use of a portable unit containing software for recording, storing and analyzing pertinent data, the method comprises the steps of turning on the portable unit and entering name and date and inputting the name of a golf course being played along with course information including par, slope rating, individual hole pars, and yardage. The next step is inputting the score on each hole played and answering questions asked by the portable unit including, “Did you hit the fairway in regulation?”, “Did you hit the green in regulation?”, and “How many putts, penalties and hazard strokes were taken on this hole?”. There is a step of asking the portable unit to calculate user's current handicap as well as other statistics and displaying the information on today's round of golf along with displaying averages for past rounds on this golf course as well as averages for the year and a step of displaying statistical information on such strengths and weaknesses of the golfer.

The method further includes the step of sending the inputted data to a personal computer. This can be a home computer, a work computer, laptop or whatever. The method also includes a step of printing user's handicap as well as other statistics from the personal computer.

The method includes a step of printing a label with the user's handicap from the label printer 12 disposed in the portable unit 2.

Thus, the present invention provides a Golf Handicap and Statistical Display Unit (GHSD). Such unit is a portable handheld unit that can calculate a golf handicap as well as other statistics needed to determine game strengths and weaknesses. The unit measures approximately 5 inches long by 3 inches wide and about ½ inch thick. The unit features many of the characteristics of existing PDAs and label makers. Software in the apparatus will record, store and analyze pertinent data. The apparatus is battery powered and is capable of being used or charged by a 110 volt power source. A USB port enables the golfer to send statistical information to a home or other computer. The unit has a large easy to read display screen and an alphanumeric keypad.

A swiveling attachment provides a means of securing the unit to a golfer's belt, golf bag or golf cart steering wheel. After turning on the GHSD unit, the golfer will enter their name, date and whether or not this specific course has been played before. If new, the golfer will then enter the course's name, par slope rating, individual holes par and yardage. As they play, the golfer will input their score as well as answer questions being asked by the unit including, “Did you hit the fairway in regulation?”, “Did you hit the green in regulation?” and “How many putts, penalties and hazard scores on this hole?”. After the round is finished, the unit will calculate user's current handicap and other statistics. It will provide information on today's round, averages for past rounds on this course and averages for the year. The unit's memory capability is able to store and recall up to 40 individual entries, including handicap and statistical display information. After playing the appropriate number of rounds, the unit will ask the golfer if he/she would like to print a USGA handicap label. The device is capable of printing the label with a label printer disposed on the portable unit or the label can be sent and printed on a home computer. With this label, the user will attach their current handicap to a wallet-sized handicap card, which is presented to tournament directors or fellow competitors as required. The apparatus is helpful for both beginning and more experienced golfers.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for calculating a golfer's handicap and other statistics for determining such golfer's strengths and weaknesses, said apparatus comprising:
(a) a portable unit containing software for recording, storing and analyzing pertinent data, said portable unit having a predetermined size and a predetermined shape;
(b) a keyboard disposed on a front side of said portable unit for entering data, said keyboard having an alphanumeric keypad and function keys;
(c) a display screen disposed on said front side and closely adjacent said keyboard of said portable unit for displaying information and for requesting input from a user;
(d) a means for outputting analyzed data that had been previously inputted into said portable unit; and
(e) a power means disposed in said portable unit for providing power to said portable unit.

2. The apparatus, according to claim 1, wherein said apparatus further includes an attachment means for securing said portable unit to one of a golfer's belt, golf bag and a golf cart.

3. The apparatus, according to claim 1, wherein said predetermined size of said portable unit is between about 4¾ and about 5¼ inches long and between about 2¾ and about 3¼ inches wide.

4. The apparatus, according to claim 1, wherein said portable unit further includes a label printer for printing such golfer's handicap.

5. The apparatus, according to claim 1, wherein said portable unit further includes a universal serial bus connector for sending data to a personal computer.

6. The apparatus, according to claim 1, wherein said means for outputting analyzed data includes displaying such outputted data on said display screen on said portable unit.

7. The apparatus, according to claim 1, wherein said portable unit features characteristics of existing Personal Digital Assistants.

8. The apparatus, according to claim 1, wherein said power means includes at least one battery disposed in said portable unit.

9. The apparatus, according to claim 2, wherein said attachment means includes adjustable hook and loop strips for attachment to one of a golf bag, a golf cart and a steering wheel of a golf cart.

10. The apparatus, according to claim 1, wherein said apparatus further includes yes and no keys disposed on said front side of said portable unit.

11. The apparatus, according to claim 1, wherein said apparatus further includes a directional control disposed on said front side of said portable unit for moving a cursor up and down and left and right.

12. The apparatus, according to claim 2, wherein said attachment means includes a swivel arrangement.

13. A method of calculating a golfer's handicap and other statistics for determining a golfer's strengths and weaknesses, through the use of a portable unit containing software for recording, storing and analyzing pertinent data said method comprising:
(a) turning on said portable unit;
(b) inputting course information including par, slope rating, individual hole pars, and yardage;
(c) inputting score on each hole played;
(d) calculating user's current handicap as well as other statistics;
(e) displaying information on today's round of golf; and
(f) displaying averages for past rounds on this course as well as averages for the year.

14. The method, according to claim 13, wherein said method further includes the step of sending said inputted data to a personal computer.

15. The method, according to claim 14, wherein said method further includes a step of printing user's handicap as well as other statistics from said personal computer.

16. The method, according to claim 13, wherein said method includes a step of printing a label with said user's handicap from a label printer disposed in said portable unit.

17. The method, according to claim 13, wherein said method includes a step of securing said apparatus to one of a golfer's belt, golf bag and a golf cart.

18. The method, according to claim 13, wherein said method includes a step of entering the date and the course being played as requested by said portable unit.

19. The method, according to claim 13, wherein said method includes a step of answering questions asked by said portable unit including, “did you hit the fairway in regulation?”, “did you hit the green in regulation?” and “how many putts, penalties and hazard strokes were taken on this hole?”.

20. The method, according to claim 13, wherein said method includes a step of displaying statistical information on such strengths and weaknesses.
